(19) United States
(12) Patent Application Publication
(10) Pub. No.: US 2009/0121022 A1
(43) Pub. Date: May 14, 2009

(54) Cleaning Structure for an Induction Reader

(76) Inventors: Hong-Chun TENG, Taichung (TW); Chih-Mao SHIAO, Taichung (TW); Ming-Chih HUANG, Taichung (TW)

Correspondence Address: Dr. BANGER SHIA, 102 Lindencrest Ct., Sugar Land, TX, 77479-5201, US

(21) Appl. No.: 11/936,787

(22) Filed: Nov. 8, 2007

(51) Int. Cl. G06K 7/06

(52) U.S. Cl. 235/441

(57) ABSTRACT

A cleaning structure for an induction reader is mounted on an induction reader and moves with respect to a ruler. The cleaning structure comprises: a removing portion with a predetermined angle or curve, the removing portion is provided with an assembling portion at one side thereof facing the induction reader, and on the other side of the removing portion is formed an abutting portion. By such arrangements, the angle or curved type clean structure can use the slope of the removing portion to contact and push the obstacles towards both sides of the ruler. The cleaning structure not only has a light structure weight but also the resistance against pushing the obstacles is reduced.

### BACKGROUND OF THE INVENTION

1. Field of the Invention

The present invention relates to a cleaning structure, and more particularly to a cleaning structure for an induction reader.

2. Description of the Prior Art

In order to maintain accuracy during movement, the existing machines are usually provided with a ruler 10 and an induction reader 20 (as shown in FIGS. 1 and 2), the induction reader 20 can be an optical scale or magnetic ruler which moves with respect to the ruler 10 to form a magneto-inductive path. A cleaning structure 30 is disposed on the induction reader 20 to clean obstacles (in solid or liquid form) off the ruler 10. However, in practice, such a cleaning structure still has the following disadvantages:

The cleaning structure 30 contacts the obstacles in a surface-to-surface manner, when impacting the obstacles with front surface and bearing the whole weight of the obstacles, the cleaning structure 30 is likely to deform and must be replaced frequently, which not only wastes the material but also increases cost.

The present invention has arisen to mitigate and/or obviate the afore-described disadvantages.

### SUMMARY OF THE INVENTION

The primary objective of the present invention is to provide a cleaning structure for an induction reader, wherein the cleaning structure utilizes a guiding portion with a predetermined angle to clean off the obstacles.

To achieve the above objective, a cleaning structure for an induction reader is mounted on an induction reader and moves with respect to a ruler. The cleaning structure comprises: a removing portion with a predetermined angle or curve, the removing portion is provided with an assembling portion at one side thereof facing the induction reader, and on the other side of the removing portion is formed an abutting portion. By such arrangements, the angle or curved type clean structure can use the slope of the removing portion to contact and push the obstacles towards both sides of the ruler. The cleaning structure not only has a light structure weight but also the resistance against pushing the obstacles is reduced.

### BRIEF DESCRIPTION OF THE DRAWINGS

FIG. 1 is a perspective view of a conventional cleaning structure for an induction reader;

FIG. 2 is an operational view of the conventional cleaning structure for an induction reader;

FIG. 3 is a perspective view of a cleaning structure for an induction reader in accordance with the present invention;

FIG. 4 is an operational view of the cleaning structure for an induction reader in accordance with the present invention;

FIG. 5 is a plan view of the cleaning structure of FIG. 2;

FIG. 6 is a plan view of showing a cleaning structure for an induction reader in accordance with a second embodiment of the present invention;

FIG. 7 is a plan view of showing a cleaning structure for an induction reader in accordance with a third embodiment of the present invention;

FIG. 8 is a plan view of showing a cleaning structure for an induction reader in accordance with a fourth embodiment of the present invention;

FIG. 9 is a plan view of showing a cleaning structure for an induction reader in accordance with a fifth embodiment of the present invention;

FIG. 10 is a plan view of showing a cleaning structure for an induction reader in accordance with a sixth embodiment of the present invention;

FIG. 11 is a plan view of showing a cleaning structure for an induction reader in accordance with a seventh embodiment of the present invention;

FIG. 12 is a plan view of showing a cleaning structure for an induction reader in accordance with an eighth embodiment of the present invention;

FIG. 13 is a plan view of showing a cleaning structure for an induction reader in accordance with a ninth embodiment of the present invention; and

FIG. 14 is a plan view of showing a cleaning structure for an induction reader in accordance with a tenth embodiment of the present invention.

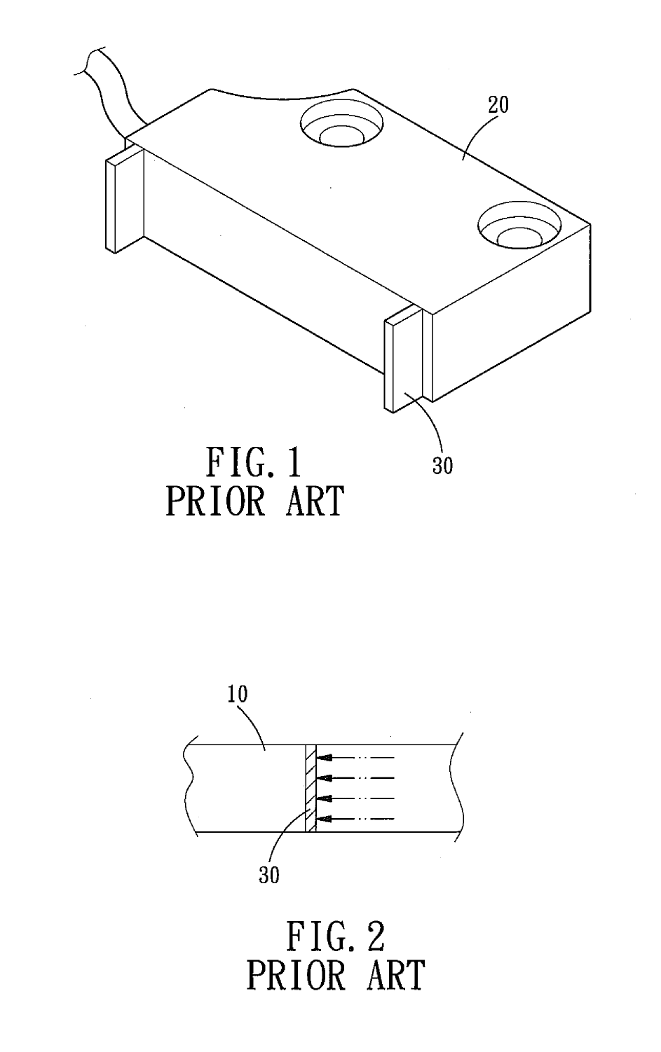

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

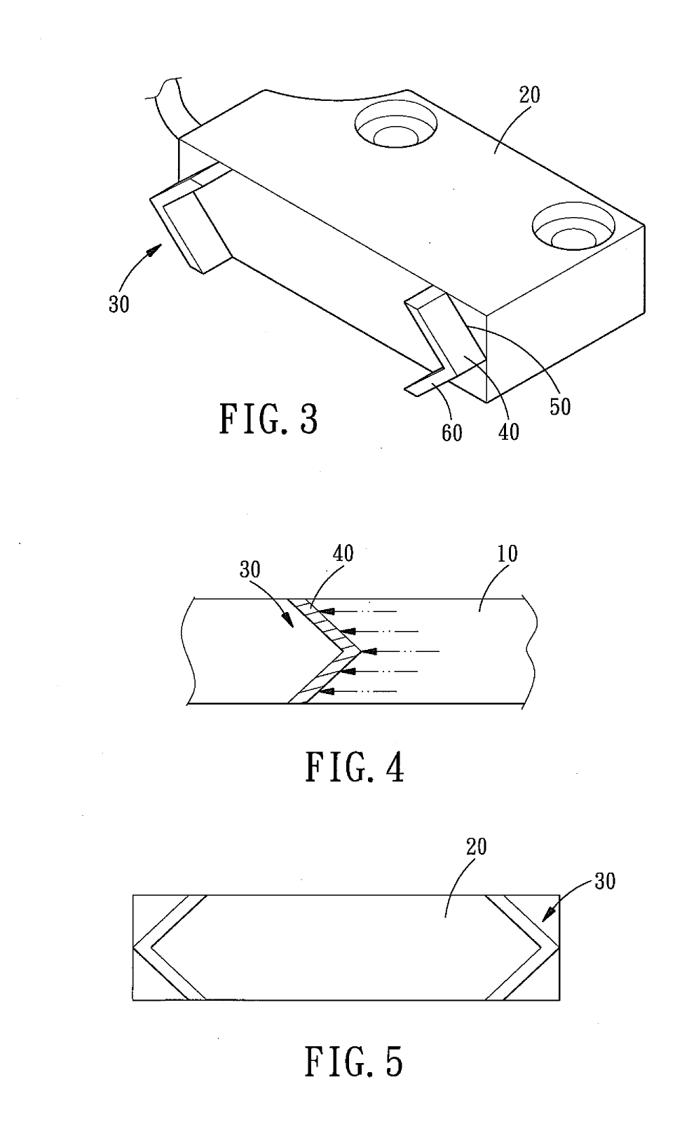

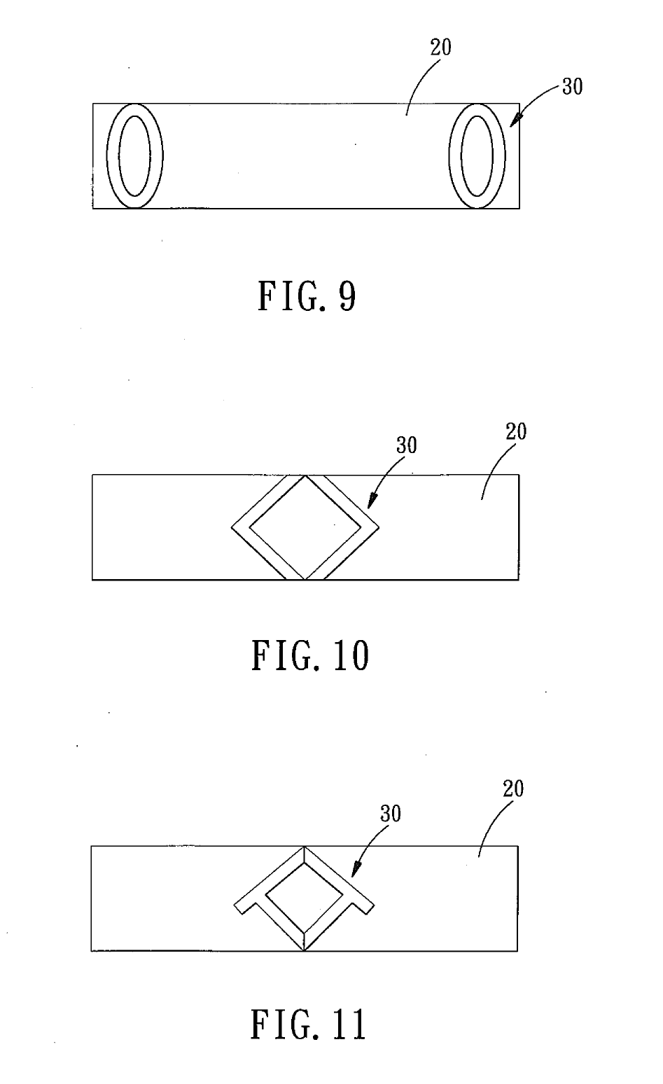

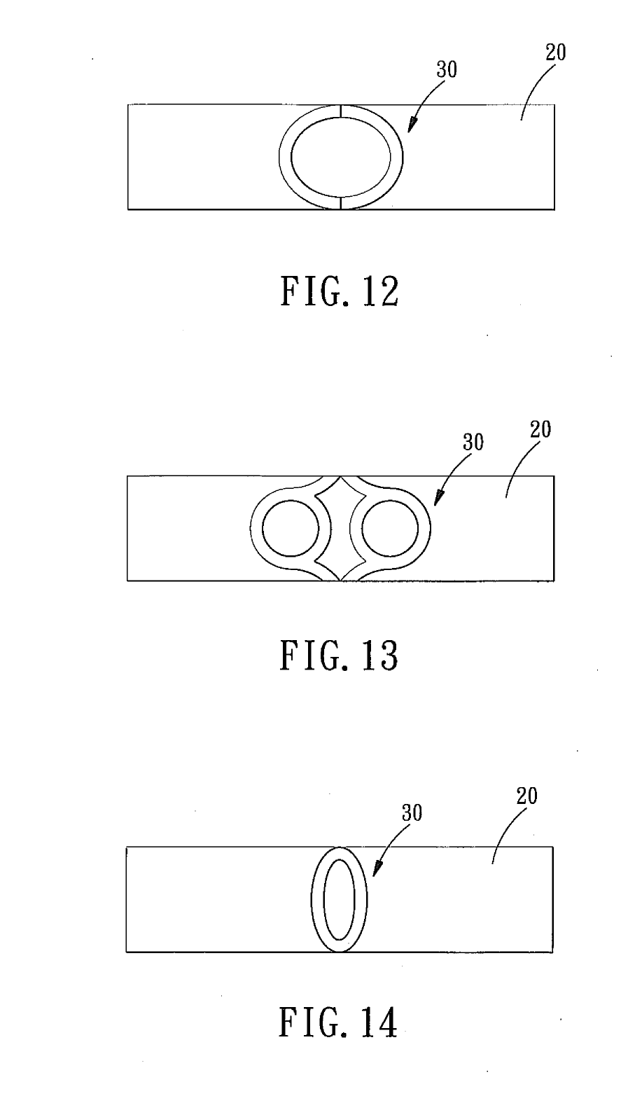

Referring to FIGS. 3-14, a cleaning structure 30 for an induction reader in accordance with the present invention is shown and comprises a removing portion 40 which is formed with a predetermined angle or curvature. The removing portion 40 is provided at one side thereof with an assembling portion 50 facing the induction reader and on the other side thereof with an abutting portion 60. The removing portion 40 is adjacent to the assembling portion 50 and the abutting portion 60. Through the assembling portion 50, the cleaning structure 30 is mounted to both ends or the center of the surface of the induction reader 20 facing the ruler 10, and the cleaning structure 30 is located between the induction reader 20 and the ruler 10.

What follows are the descriptions of two embodiments of the cleaning structure 30:

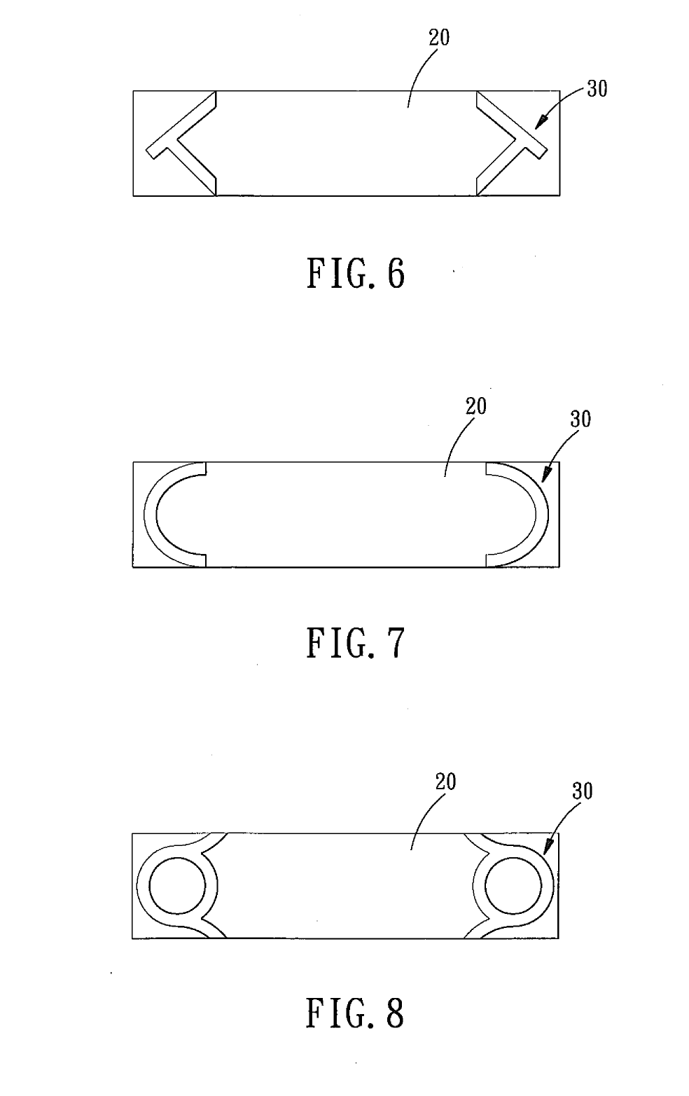

First, angle type: the removing portions 40 of the two cleaning structures 30 are (as shown in FIG. 5) are <-shaped and >-shaped (as shown in FIG. 5), respectively, or are formed in the shapes as shown in FIG. 6, and the removing portions 40 are located at both ends of the induction reader 20, as shown in FIGS. 5 and 6, or they can be connected to each other to form a ⋄-shaped structure (as shown in FIG. 10) or to form the structure as shown in FIG. 11.

Second, curved type: the removing portions 40 of the two cleaning structures 30 are (as shown in FIG. 7) are arc-shaped (as shown in FIG. 5), respectively, or are formed in the shapes as shown in FIG. 8, and the removing portions 40 are located at both ends of the induction reader 20, as shown in FIGS. 7 and 8, or they can be connected to each other to form a -shaped structure (as shown in FIG. 13) or to form the structure as shown in FIG. 14.

For a better understanding of the present invention, reference should be made to FIGS. 3-14 again.

When in use, the cleaning structure 30 is mounted to the surface of the induction reader 20 through the assembling portion 50, and when the induction reader 20 moves relative to the ruler 10, the abutting portion 60 of the cleaning structure 30 contacts the ruler 10, and the removing portion 40 of the cleaning structure 30 moves along with the induction reader 20 to clean off the obstacles on the ruler 10. By such arrangements, the angle or curved type clean structure 30 can use the slope of the removing portion 40 to contact and push the obstacles towards both sides of the ruler 10.

To summarize, a cleaning structure for an induction reader is mounted on an induction reader and moves with respect to the ruler. The cleaning structure comprising a removing portion which is formed with a predetermined angle or curvature. The cleaning structure moves along with the induction reader to clean the obstacles off the scale. The cleaning structure not only has a light structure weight but also the resistance against pushing the obstacles is reduced.

While we have shown and described various embodiments in accordance with the present invention, it is clear to those skilled in the art that further embodiments may be made without departing from the scope of the present invention.

What is claimed is:

1. A cleaning structure for an induction reader mounted on an induction reader and moving with respect to an ruler, comprising:
a removing portion with a predetermined angle, the removing portion being provided with an assembling portion at one side thereof facing the induction reader, and on the other side of the removing portion being formed an abutting portion.

2. The cleaning structure for an induction reader as claimed in claim 1 is mounted to both ends of a surface of the induction reader facing the ruler by the assembling portion.

3. The cleaning structure for an induction reader as claimed in claim 1 is mounted at a center of a surface of the induction reader facing the ruler by the assembling portion.

4. A cleaning structure for an induction reader mounted on an induction reader and moving with respect to an ruler, comprising:
a removing portion with a predetermined curve, the removing portion being provided with an assembling portion at one side thereof facing the induction reader, and on the other side of the removing portion being formed an abutting portion.

5. The cleaning structure for an induction reader as claimed in claim 4 is mounted to both ends of a surface of the induction reader facing the ruler by the assembling portion.

6. The cleaning structure for an induction reader as claimed in claim 5 is mounted at a center of a surface of the induction reader facing the ruler by the assembling portion.
